(19) United States
(12) Patent Application Publication
(10) Pub. No.: US 2011/0076995 A1
(43) Pub. Date: Mar. 31, 2011

(54) SYSTEM AND METHOD FOR PROVIDING MULTIMEDIA OBJECT LINKED TO MOBILE COMMUNICATION NETWORK

(75) Inventor: Tae Yun Kim, Incheon (KR)

(73) Assignee: LOGICPLANT CO., LTD., Seoul (KR)

(21) Appl. No.: 12/993,577

(22) PCT Filed: May 8, 2009
(86) PCT No.: PCT/KR09/02427

§ 371 Date: Nov. 19, 2010

(30) Foreign Application Priority Data
May 22, 2008 (KR) 10-2008-0047492

(51) Int. Cl. H04W 4/00

(52) U.S. Cl. 455/415

(57) ABSTRACT

A system and method for providing a multimedia object linked to the mobile communication network is provided. The method includes: (a) the mobile device detecting a ringing signal or call signal of a call; (b) the mobile device extracting a phone number from the detected ringing signal or call signal; (c) the mobile device requesting the expression object server for a multimedia expression object corresponding to the extracted phone number; (d) the expression object server searching a multimedia expression object corresponding to the extracted phone number and transmitting it to the mobile device; and (e) the mobile device displaying the multimedia expression object at least one of the times for originating a call, receiving a call, in the middle of a call and at the end of a call.

### TECHNICAL FIELD

The present invention relates to a system and a method for providing a multimedia object linked to the mobile communication network, wherein a user transmits a multimedia expression object he or she has set up to the terminal of a communication party via a data communication network so as to make the object displayed on the terminal at the time of originating a call or receiving a call, in the middle of a call, or at the end of a call and to allow an interaction with the multimedia expression object displayed on the terminal.

### BACKGROUND ART

Generally, a mobile terminal is an apparatus for exchanging information with a communication party by establishing voice communication with the communication party via a mobile communication network. The mobile terminal having such a function is provided with various services. The services are classified into the followings based on information exchange and networks.

Firstly, there is a service for information exchange between user parties as the original purpose of the terminal. This service provides an information exchange method besides voice communication or a method for establishing voice communication while performing the exchange of additional information. A representative service of the former is Short Message Service (SMS), a representative service of the latter is a video communication system. Meanwhile, there is a service for a user's information to a communication party regardless of the user's intention, an example of which is the caller identification service.

Secondly, there is a service which uses the voice or data communication function of the mobile communication network but is personally utilized by a user directly regardless of information exchange between user parties. Examples of this service include a personal ring-back-tone service, a ring service, a service for enabling a user to download and play games or music, a service for enabling a user to directly access to Internet and to do web surfing, a service for facilitating the input of Internet addresses, or the like. These services implement the general functions of the mobile terminal in which networking is implemented using the data communication function of the mobile communication network.

Thirdly, there is a service using only it's own operation function and display function of a portable phone regardless of information exchange or networking. Examples of this service include a ‘set wallpaper’ service, unique user interfaces having a touch function, or the like. These services are mainly implemented by programs installed on a terminal by a terminal manufacturer.

Fourthly, there is a service having the purpose of purely representing and showing off a user oneself to a communication party rather than the purpose of information exchange. The fourth type of service is similar to the first type of service with respect to its system, their particular purposes are different from each other. Representatives of this type of services include a “color ring service” for enabling a party that makes a phone call to a user to listen to music previously selected by the user instead of a dial tone and a “lettering service” for enabling a communication party to see a sentence previously selected by a user when making a phone call.

The fourth service is an attractive service in that which this service is not necessarily needed for human's life but satisfies human fundamental desires. This type of service is well utilized actually, and a good revenue source for a service provider.

However, existing services have considerable limitations in the time point and period of expression due to the limitations of theirs ideas. For example, in the color ring service, music is replaced with a dial tone, so that when a party receives a call, the music stops to play. In the lettering service, the sentence is shown only during waiting for response to a call. Such limitations act to considerably restrict the enrichment of expression data, such as music or sentences.

Furthermore, the expression data does not perform interaction due to limitations in expression time, such as during origination or reception of a call, and therefore is output in a unilateral expression method so that interaction with the expression data as the user controls application programs is impossible.

These services have been developed to transmit multimedia data besides a simple sound or text but limitations in the above-described expression time, period and interaction are still maintained.

Meanwhile, these services which are performed in a server within a mobile communication network system have a problem in that the extension or modification in the mobile communication network system are needed in order for the improvement and extension of functionality or introduction of new ideas, thereby causing the consumption of great expense.

### DISCLOSURE

### Technical Problem

An object of the present invention is to a system and a method for providing a multimedia object linked to a mobile communication network, in which a user transmits a multimedia expression object he or she has set up to the terminal of a communication party in a call via a data communication network so as to make the object displayed on the terminal at the time of originating a call or receiving a call, in the middle of a call, or at the end of a call and to allow an interaction with the multimedia expression object displayed on the terminal.

### Technical Solution

In one general aspect, a method for providing a multimedia object in a system including an expression object server for providing multimedia expression objects to a mobile device for performing voice communication and data communication, includes: (a) the mobile device detecting a ringing signal or call signal of a call; (b) the mobile device extracting a phone number from the detected ringing signal or call signal; (c) the mobile device requesting the expression object server for a multimedia expression object corresponding to the extracted phone number; (d) the expression object server searching a multimedia expression object corresponding to the extracted phone number and transmitting it to the mobile device; and (e) the mobile device displaying the multimedia expression object at least one of the times for originating a call, receiving a call, in the middle of a call and at the end of a call.

The method may include (f) a user information device manufacturing a multimedia expression object; and (g) the user information device transmitting the manufactured multimedia expression object to the expression object server to store and register it.

In the step of (d), the mobile device may cache the multimedia expression object received from the expression object server in a storage device and re-uses the multimedia expression object.

The multimedia expression object may include still images including a character string or a photograph, moving images, music and vibration data, and may be output via a screen output device, a sound output device, or a vibration output device of the mobile device.

The multimedia expression object may include an interaction object including buttons, icons, or menus, and the mobile device may output various expression results by interacting with the user via the interaction object.

In another general aspect, a system for providing a multimedia object, includes a user mobile device for performing voice communication and data communication and requesting a communication party's terminal to transmit a first multimedia expression object or receiving and outputting a second multimedia expression object resulting from a request of the communication party's terminal; and an expression object server connected to the user mobile device via a data communication network for storing an multimedia expression object corresponding to a phone number of the user mobile device or the communication party's terminal and transmitting the first multimedia expression object or the second multimedia expression object corresponding to a phone number requested by the user mobile device of the communication party's terminal to the communication party's terminal or the user mobile device.

The multimedia expression object may include sense information including sight, hearing and touch which can be expressed by the user mobile device and one or more among user interface objects which can interact with a user to derive corresponding results.

The user mobile device and the communication party's terminal may perform a request including additional conditions including time and date at a time point of the request, and location of a requesting user besides the phone number when requesting the expression object server for the multimedia expression object.

The expression object server may store a number of phone numbers to correspond to one multimedia expression object.

The multimedia expression object may include indirect data referring to data of an external storage besides multimedia data, and the user mobile device or the communication party's terminal may access to a server indicated by the referred data and download the indirect data when receiving the multimedia expression object.

The multimedia expression object may include machine codes executable in the user mobile device or the communication party's terminal or script codes executable in a script engine of the user mobile device or the communication party's terminal.

The system may further include a user information device for manufacturing the multimedia expression objects and uploading them to the expression object server.

When the user mobile device or the communication party's terminal originates or receives a SMS message or a multimedia message, the expression object server may transmit the multimedia expression object corresponding to a phone number of a party for receiving the corresponding message to the communication party's terminal or the user mobile device.

In another general aspect, a system for providing a multimedia object includes: an output unit for detecting an originated or terminated call signal related to voice communication and communicating with an expression object server for providing a multimedia express object related to the voice communication; an output unit for outputting the multimedia expression object; an expression object processor for extracting a phone number from the originated or terminated call signal, caching the multimedia expression object received from the communication unit or outputting the multimedia expression object the output unit; and a control unit for performing control so as to extract the phone number from the originated or terminated call signal and to request and receive the multimedia expression object corresponding to the extracted phone number from the expression object server when the originated or terminated call signal is detected.

The user mobile device may further include an input unit for inputting a phone number related to the originated call and a command requesting voice communication.

The expression object processor may continue to output the multimedia expression object after the voice communication has been terminated and stop to output the multimedia expression object according to a separate event or a stop commend from a user.

When an originated or terminated signal of a SMS message or a multimedia message is detected, the control unit may request the multimedia expression object corresponding to a phone number of a party related to the corresponding message from the expression object server.

When the received multimedia expression object includes indirect data referring to data of an external storage, the control unit may access to a server indicated by the referred data and download the indirect data.

In another general aspect, an expression object server includes a communication unit for receiving a message requesting a multimedia expression object corresponding to a phone number related to an originated or terminated call from a mobile device; an expression object storage for storing a number of multimedia expression objects; an expression object searcher for searching for the multimedia expression object corresponding to the phone number from the expression object storage; and a control unit for searching for the multimedia expression object corresponding to the phone number when the message requesting the multimedia expression object and transmitting the multimedia expression object corresponding to the phone number to the mobile device via a data communication network.

The message requesting the multimedia expression object may include additional conditions including time and date at a time point of the request, and location of a requesting user.

### ADVANTAGEOUS EFFECTS

According to the present invention, both users that communicate with each other may output a previously prepared expression object to the mobile device of their communication party in multimedia at the time of originating a call or receiving a call, in the middle of a call, or at the end of a call.

Furthermore, a user can interact with the expression object of a communication party output to the user's own mobile device, thereby enabling communication between various personals.

Furthermore, there is an advantage in that minimum establishment and introduction cost is consumed since the present invention can be established without extension or modification in an existing mobile communication network.

In addition, additional service business models, such as provision of fundamental ancillary data of expert levels included in the expression object, expanded service provision based on the expression objects of executable types, or the like may be suggested, thereby creating a new market.

### DESCRIPTION OF DRAWINGS

The above and other objects, features and advantages of the present invention will become apparent from the following description of preferred embodiments given in conjunction with the accompanying drawings, in which:

FIG. 1 is a configuration diagram schematically showing the configuration of a system for providing a multimedia object linked to mobile communication networks according to an embodiment of the present invention;

FIG. 2 is a configuration diagram schematically showing the internal configuration of a user mobile device according to an embodiment of the present invention;

FIG. 3 is a configuration diagram schematically showing the internal configuration of an expression object server according to an embodiment of the present invention; and

FIG. 4 is a diagram showing a method for providing a multimedia object linked to mobile communication networks according to an embodiment of the present invention 1.

### BEST MODE

Hereinafter, an embodiment of the present invention will be described in detail with reference to the accompanying drawings.

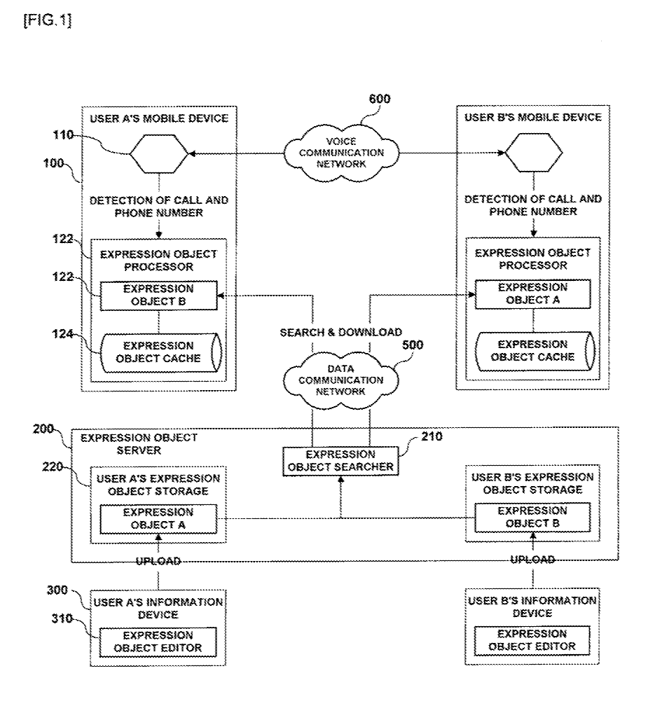

FIG. 1 is a configuration diagram schematically showing the configuration of a system for providing a multimedia object linked to mobile communication networks according to an embodiment of the present invention.

Referring to FIG. 1, in the system for providing a multimedia object according to the present invention, a user mobile device 100, an expression object server 200 and a user information device 300 are communicatively connected to each other via a data communication network 500.

The user mobile device 100 is connected to a voice communication network 600 so as to perform voice communication with another user's mobile device via the voice communication network 600.

An expression object processor 120 is installed or mounted in the user mobile device 100, and an expression object editor 310 is installed in the user information device 300.

In this case, the data communication network 500 includes wired high speed Internet, such as LAN, xDSL, Cable, or the like, wireless LAN, telephone modem, mobile communication, data communication network. Furthermore, the user mobile device 100 includes all personal mobile communication terminals which can establish voice communication regardless of the kinds of devices, such as a portable phone, PDA or the like, and be connected to the data communication network via wired or wireless access during the voice communication.

The user information device 300 includes all information devices which can be connected to the data communication network via wired or wireless access regardless of the kinds of devices, such as a portable phcine, PDA, PC or the like, and operate the expression object editor 310.

Meanwhile, the voice communication network 600 includes all types of network networks which establish voice communication with the user mobile device 100. In a case where the user mobile device 100 uses the data communication network during voice communication, the voice communication network 600 is identical to the data communication network 500.

The expression object processor 120 embedded or installed in the user mobile device 100 outputs the expression object 122 received from the expression object server 200 or stored in an expression object cache 124 to the screen of the mobile device and other output devices in response to an expression object output initiation event.

A communication unit 110 for detecting a call request signal and a telephone number received from the voice communication network 600 is provided in the user mobile device 100.

The user information device 300 includes the expression object editor 310 which edits the expression object 122 that a user intends to show to a communication party and transmits it to the expression object server 200. In this case, the expression object editor 310 performs a function of receiving and editing the expression object 122 stored in the expression object storage 220 of the expression object server 200 and transmitting it back to the expression object server 200, and a function of outputting the edited expression object 122 to the user information device 300 in a format to be actually seen by the communication party.

The expression object server 200 includes an expression object searcher 210 which searches for and extracts the expression object 122 from the expression object storage 220 and transmits it to the expression object processor 120 when the expression object processor 120 of the user mobile device 100 requests the expression object 122.

Furthermore, the expression object server 200 functions to receive the expression object 122 edited by the expression object editor 310 of the user information device 300 and store it in the expression object storage 220. In this case, an RDBMS (relational database management system) may be used to search for the expression object 122 for efficiency in a case where a number of users exist.

Several expression objects 122 may be exist for a user as described above, so that different expression objects 122 may be provided according to called parties or additional information, such as time, day, the locations of the called parties, or the like.

In order to provide different expression objects 122 depending on called parties, telephone number data transmitted to the expression object searcher 210 must include not only the telephone number of a communication party, but also the telephone number of a calling party.

In contrast, in the case where a system is configured such that a single expression object 122 exists for a user, only the telephone number of a communication party is to be transmitted. In the case in which additional information, such as time, day, the locations of called parties, or the like is used, the corresponding additional information is to be additionally transmitted, and the expression object server 200 may process partial information, such as day or the like by itself.

Furthermore, the expression object server 200 is forced to be connected to general networks coupled to mobile communication networks or wireless communication networks and the mobile device and the expression object server are force to perform general client and server operations respectively, so that the system according to the present invention can be established without extension or modification in an existing mobile communication network.

The expression object server 200 may be divided into two types of separate servers for playing different roles.

The first server is an expression object search server. The expression object search server includes the expression object searcher 210 which extracts information about access to the expression objects stored in the expression object server based on telephone numbers and other additional information. The second server is an expression object storage server. The expression object storage server includes the expression object storage 220.

In this case, two methods for receiving the expression object 122 by the user mobile device 100 are possible.

According to the first method, the user mobile device 100 accesses to the expression object search server and receives the information about access to the expression object including the address of the expression object storage server, and accesses to a suitable expression object storage server based on the information to receive the expression object.

According to the second method, the expression object search server plays the role of a relay server which internally accesses to the expression object storage server to receive the expression object 122 and transmits it to the user mobile device 100. In this method, the user mobile device 100 is provided with virtually integrated server functions, so that the user mobile device 100 completely recognizes the corresponding integrated server functions as the expression object server 200 and performs its operation.

Meanwhile, unlike that the expression object server 200 is divided into several servers according to its roles as described above, it is possible to provide several of one logical expression object server 200. In this case, the expression object processor 120 of the user mobile device 100 and the expression object editor 310 of the user information device 200 may be connected to appropriate one of these expression object servers 20 to transmit the expression object 122. In this case, three ways to select the expression object server 200 are possible.

The first way is that the expression object processor 120 and the expression object editor 310 directly select one according to a predetermined rule, for example, a remainder value resulting from division of the value of the last few digits of the telephone number of the communication party by a specific number.

The second way is that a separate selection server is provided in the expression object server 200, and the expression object processor 120 and the expression object editor 310 access to the selection server to receive the selection results.

The third way is that the expression object server 29 is transparently configured in parallel using an address sharing system and a load balancing system, and expression object processor 120 and the expression object editor 310 access to a corresponding shared address.

Meanwhile, in the case where the expression object server 200 is divided into two types of servers according to its roles and the user mobile device 100 is directly connected to the respective server, that is, the address of the expression object storage server is included in the information about access to the expression object, the expression object storage servers may be configured by several servers having independent addresses without particular limitations.

For reference, methods to divide the expression object server 200 as described above are details to be implemented and the core ideas of the present invention can be maintained regardless of the methods. Accordingly, although the division method is modified, it is impossible to depart from the scope of the present invention as long as it provides functions identical to those of the system according to the present invention.

### MODE FOR INVENTION

FIG. 2 is a configuration diagram schematically showing the internal configuration of a user mobile device according to an embodiment of the present invention.

Referring to FIG. 2, the user mobile device 100 includes a communication unit 110, an expression object processor 120, a control unit 130, an input unit 140 and an output unit 150.

The communication unit 110 detects originated or terminated calls related to voice communication. Furthermore, the communication unit 110 transmits and receives voice signals or multimedia data related to mobile communication via mobile communication networks. In this case, a detection unit for detecting originated or terminated calls related to voice communication may be configured separately from the communication unit 110.

In addition, the communication unit 110 includes a mobile communication module which can communicate with CDMA 1× EV-DO networks, WCDMA networks, HSDPA networks, HSUPA networks or Wibro networks.

The expression object processor 120 functions to output the multimedia expression object received from the expression object server 200 to the output unit 150. In this case, the expression object processor 120 may be included in the control unit 130 or may be separately configured to output the multimedia expression object to the control unit 130.

In addition, the expression object processor 120 may be a module included in the system software of the user mobile device or an application program running in application program running environment. In both cases, the expression object processor 120 performs operations in response to an event related to an originated or terminated call provided by the hardware or system software of the mobile device. Accordingly, the expression object processor 120 may be initiated at a time point at which the event occurs and perform the above-described operations or may run quietly in the background, and when the event is received, perform the above-described operations.

When the originated or terminated call related to voice communication by the communication unit 110, the control unit 130 extracts a telephone number from the originated or terminated call, and requests the multimedia expression object corresponding to the extracted telephone number from the expression object server 200 to control the reception of the multimedia expression object corresponding to the telephone number from the expression object server 200. Furthermore, the control unit 130 performs control such that the multimedia expression object is output to the output unit 150 via the expression object processor 120. As a result, the expression object processor 120 may be separately configured as in FIG. 1, but may be included in the control unit 130.

The input unit 140 is for inputting a command for voice communication or a telephone number for voice communication. For this, the input unit 140 includes a plurality of buttons with letters, numbers and symbols.

The output unit 150 is a device for outputting the multimedia expression objects, and includes a screen output device for outputting the multimedia expression objects onto a screen and a sound output device for outputting sound, and a vibration output device for outputting vibrations.

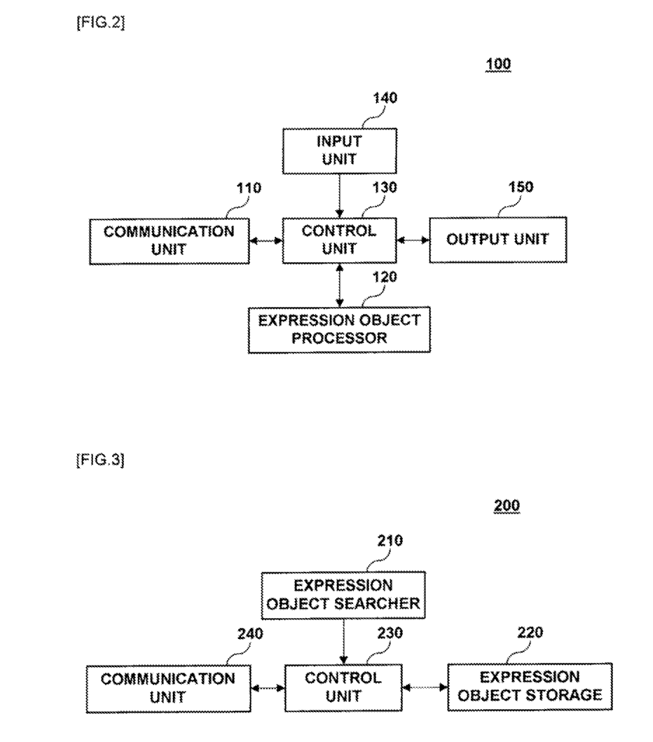

FIG. 3 is a configuration diagram schematically showing the internal configuration of an expression object server according to an embodiment of the present invention.

Referring to FIG. 3, the expression object server 200 according to the present invention includes the expression object searcher 210, the expression object storage 220 and the communication unit 240.

The expression object searcher 210 searches for the multimedia expression object corresponding to the telephone number received from the user mobile device 100 in the expression object storage 220.

The expression object storage 220 stores the telephone number of the user mobile device 100 and its corresponding multimedia expression object.

In this case, the multimedia expression object includes sense information, such as sight, hearing and touch which can be expressed by the user mobile device 100 and one or more among user interface objects which can interact with a user to derive corresponding results.

Furthermore, the multimedia expression objects include still images including a character string or a photograph, moving images, music and vibration data and are output via the screen output device, the sound output device, or the vibration output device of the user mobile device 100.

In addition, the multimedia expression objects include interaction objects including buttons, icons, or menus.

Furthermore, a number of telephone numbers may correspond to one multimedia expression object.

In addition, the multimedia expression objects may include machine codes executable in the user mobile device 100 or script codes executable in the script engine of the user mobile device 100.

When the control unit 230 receives a request for the multimedia expression object from the user mobile device 100, the control unit 230 performs control to search for the multimedia expression object corresponding to a related telephone number in the expression object storage 220 via the expression object searcher 210, and to transmit the found multimedia expression object to the user mobile device 100.

The communication unit 240 communicates with the user mobile device 100 through the data communication network 500.

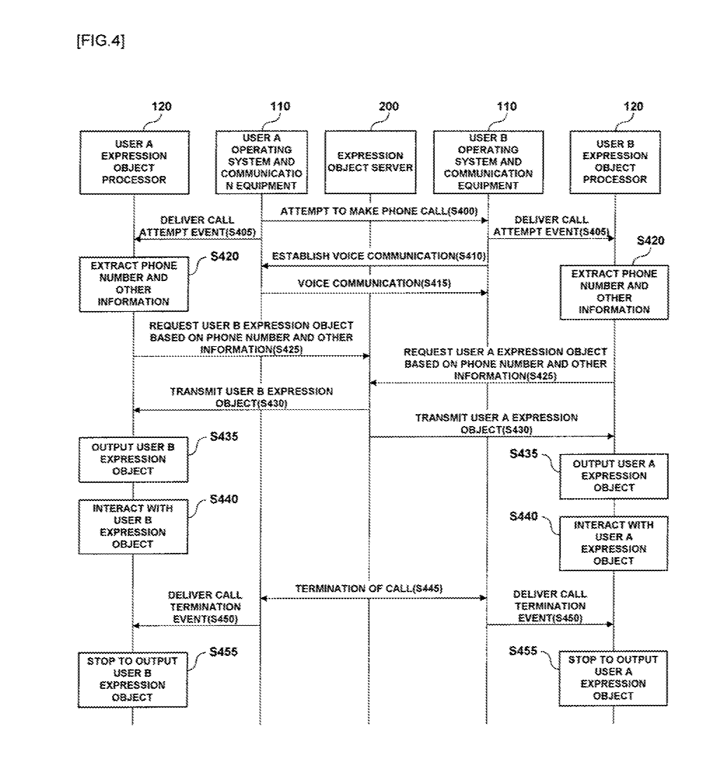

FIG. 4 is a diagram showing a method for providing a multimedia object linked to mobile communication networks according to an embodiment of the present invention.

In embodiments of the present invention, it is assumed that user A's mobile device makes a phone call to user B's mobile device of user B.

Referring to FIG. 4, first of all, user A's mobile device 100 attempts to make a phone call to user B's mobile device (S400).

In this case, the operation systems or communication units 110 of user A's mobile device and user B's mobile device deliver a call attempt event to the expression object processor 120 (S405).

In this case, the event delivery is abstract idea. In particular, the expression object processor 120 starts to perform operations related to the call attempt event in the following two ways.

Firstly, the expression object processor 120 always runs in the background in the user mobile device 100, and when an event message delivered by the operating system or the communication unit 110 upon call attempt is received, starts to perform its operations.

Secondly, environment is set such that the operating system or the communication unit 110 of the user mobile device 100 operates the expression object processor 120 upon occurrence of the call attempt event and, thereafter, when a related event occurs, the expression object processor 120 is operated to start to perform its operations according to the set environment.

After delivery of the event, the operating system or the communication unit 110 and the expression object processor 120 performs their tasks in parallel regardless of their situations.

The operating system or communication unit 110 of user B's mobile device which received the call establishes voice communication with user A's mobile device 100 (S410). Thereafter, user A's mobile device 100 and user B's mobile device perform conventional voice communication (S415).

Meanwhile, the expression object processors 120 of both user mobile devices, which start to perform voice communication, independently proceed to output the expression object of the communication party. In FIG. 4, it is shown that the expression object processor 120 of user A's mobile device 100 performs its operations earlier than the expression object processor of user B's mobile device, but this is for showing that the processors need not to simultaneously perform their operations, so that user A's mobile device 100 does not necessarily first perform its operation. Actually, depending on the performance of the respective user mobile devices 100, network environment, or whether the expression object cache 124 is hit or not, theirs processing speeds may vary, and, as a result, a time point at which the multimedia expression object 122 is output is determined.

The expression object processor 120 extracts a telephone number and other information from event data and other environment of the user mobile device 100 (S420). Furthermore, a message requesting the multimedia expression object 122 of the communication party is transmitted to the expression object server 200 based on the extracted data (S425).

When the message requesting the multimedia expression object is received, the expression object server 200 searches for appropriate multimedia expression objects 122 corresponding to the telephone numbers via the expression object searcher 210 and transmits the found multimedia expression objects 122 to the user mobile terminals respectively (S430).

In this case, when what is matched with a current request exists in the expression object cache 140 previously stored prior to occurrence of actual transmission, the expression object processor 120 may use the expression object cache 124 matched with the current request without reception from the expression object server 200. This procedure is omitted from FIG. 4.

In the user mobile device 100, the expression object processor 120 outputs the multimedia expression objects received from the expression object server 200 to the output unit 150 (S435).

Accordingly, the user interacts with the multimedia expression object output by the output unit 150 while talking over the telephone (S440).

In this case, the multimedia expression object includes interaction objects including buttons, icons, menus and the user mobile device may output various expression results while interacting with the user via the interaction objects.

In this case, the amount of the multimedia expression object is large, so that there are many cases in which transmission is inefficient. Therefore, when the multimedia expression object has been once received in the user mobile device, the multimedia expression object is cached in a storage device and is re-used.

Furthermore, the multimedia expression objects are composed of multimedia including a still image, such as a character string or a photograph, moving images, music, vibration data, or the like, and are output via the screen and sound output device, the vibration output device, or the like of the user mobile device.

In the present invention, the multimedia expression object is output at the time of originating a call or receiving a call, in the middle of a call, or at the end of a call, so that the interaction can be made for sufficient time. Furthermore, there is a problem in that a user does not sufficiently see the output of the multimedia expression object because the user holds the mobile device in contact with his or her ear during voice communication. However, in the present invention, the user can use the mobile device in the posture that the user takes to see the screen of the mobile device through functions, such as DMB viewing, music listening, video communication or the like.

The whole of the multimedia expression object or ancillary data, such as moving images, constituting it may have data formats specialized for services and may have standard data formats, such as Jpeg, MP3, H.264, XML or SVG. The specialized data formats have an advantage in that they can be optimized for corresponding services and mobile devices and the standard data formats have an advantage of using techniques verified in related fields.

The multimedia expression object may include indirect data, such as URL, referring to external data besides direct data. In this case, the expression object processor 120 accesses to a corresponding external data address and receives the data.

One multimedia expression object may be prepared commonly for all communication parties of a corresponding user, and a separate expression object may be also prepared for each classification when communication parties are classified according to the user's desires. In the latter case, the preparation loads of the user increases, but there is an advantage in that the specialized and appropriate expression for communication parties is possible.

Furthermore, separate multimedia expression object may be prepared according to not only communication parties but also additional information, such as time, day, the locations of the communication parties, or the like. In this case, corresponding additional information must be provide upon search of the multimedia expression object, and the expression object server 200 applies the corresponding additional information to the search of the multimedia expression object.

Furthermore, one multimedia expression object may correspond to a number of telephone numbers. This is available in the case where a user has several mobile devices.

The multimedia expression object may be manufactured directly by a user, but this is not easy because of limitations in general users' creativity and aesthetic sense. Therefore, for the ancillary data constituting the multimedia expression object, basic data, for example, beautiful background images or the like, available in many cases may be provided by a service provider through various accounting systems. Furthermore, a service for organizing ancillary data, for example, the own photograph of a user, provided by the user and basic ancillary data provided by the service provider in an expert level may be provided.

The spatial composition of multiple data related to images of the multimedia expression objects, that is, an expressed screen image is output onto the screen of the mobile device of a communication party as arranged by the user preparing corresponding data, thereby maximally reflecting the original intension of the user.

However, the sizes of the screens of the mobile devices are various, so that there is a case in which the screen image is not output as arranged by the user. In this case, an original expressed screen may be expended or scaled down to match with the size of the screen of the mobile device of communication party. When the original expressed screen is larger than the size of the screen, it is possible to perform scroll through a scroll bar or drag. Alternatively it is possible to appropriately move the locations of multiple data according to a ratio between the sizes of the original expressed screen and the screen of the mobile device. In order to minimize the re-arrangement of the multimedia expression objects, when the user manufactures a preset multimedia expression object, the expression object editor may notify the size of the screen of the mobile device of a corresponding communication party. The sizes of the screens of respective mobile devices may be stored by transmitting corresponding information to the expression object server 200 when respective users perform registration for usage of the system according to the present invention, and the expression object editor 310 may receives this information from the expression object server 200.

Thereafter, when the voice communication is terminated (S445), a call termination event is delivered from the communication unit 110 to the expression object processor 120 (S450).

In this case, the expression object processor 120 stops to (S455) or continues to output of the multimedia expression object 122 according to a user's request or environment settings.

Although the output and interaction of the expression object are described with relation to the call attempt event in FIG. 4, the output sequence of the expression object similar to the above-described is possible for other events besides the call attempt event.

The present invention is similar to the case where a user registers the photograph or other information of a corresponding telephone number's owner in the phone book of the user's mobile device and when an originated or terminated call event occurs in the user's mobile device, the registered photograph or other information is output on the user's mobile device. However, the present invention is fundamentally different from the above case in that expression objects set by a communication party not a user are output on the user's mobile device, thereby implementing a system for satisfying the user's desires to show and flaunt the user to the communication party. Since self-expression and its accompanying decorations are for being shown to other people, a user more actively makes an investment to improve the quality of expression objects to be shown to a party rather than expression objects used in the user's own mobile device, which will be the marketing potential of the service implemented by the present invention.

Meanwhile, besides time points related to a call, the expression objects of respective users may be output to other users to be seen as follows.

Firstly, as described above, the mobile device may continue to output the expression object after a call has been terminated and may stop to output expression object according to a separate event, such as a stop commend from a user.

Secondly, regardless of a call, the mobile device may output the expression object for the telephone number of a party related to corresponding message transmission when a message is received or transmitted by a SMS system or a system similar thereto.

Thirdly, after the input of a telephone number, it is possible to start to receive and output the expression object rather than to establish voice communication.

There is a case where a user does not want to see the expression object of a party depending on communication parties. Therefore, similarly to a system of selectively receiving a call after the display of a caller's identification, only basic information, such as a caller's name and telephone number may be first displayed on a screen and a user interface component, such as a button for the display of the expression object may be then arranged therebelow, so that when the user interface component is clicked, the expression object of the communication party may be output.

In the case where the system according to the present invention is provided as a service, two types of services are provided depending on flexibility and expansibility as follows.

The first service is a service of providing an expression object processor which previously defines the types of ancillary data constituting an expression object and outputs only the expression object composed of corresponding type of ancillary data.

The second service is a service in which executable objects are included as the ancillary data of expression objects, and the expression object processor executes a corresponding object by interacting with the corresponding object via API (Application Program Interface), so that a separate service provider or a developer manufactures or adds executable objects having such a type, thereby extending the function of the expression object processor. In this case, the addition of the expression objects may be made without modification in the mobile device and the expression data server. In this service, a separate service provider can participate in this service even after initiation of the service and suggest various supplementary features and business models, thereby creating markets.

As described above, the present invention provides a system and a method for providing a multimedia object linked to a mobile communication network, in which a user transmits a multimedia expression object he or she has set up to the terminal of a communication party in a call via a data communication network so as to make the object displayed on the terminal at the time of originating a call or receiving a call, in the middle of a call, or at the end of a call and to allow an interaction with the multimedia expression object displayed on the terminal.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims. Accordingly, the scope of the present invention should not be limited to the above-described embodiments but should be determined by not only the appended claims but also the equivalents thereof.

### INDUSTRIAL APPLICABILITY

The present invention may be applied to mobile devices which perform voice communication with a remote party and mobile communication systems which transmit and receive multimedia objects between an originator and a recipient.

Furthermore, the present invention may be applicable to communication systems for providing services having the purpose of representing and showing off a user oneself to a communication party besides the purpose of information exchange.

In addition, the present invention may be applicable to services or systems for transmitting multimedia objects selected by an originator to a recipient thereby informing the propensity of the originator.

1. A method for providing a multimedia object in a system including an expression object server for providing multimedia expression objects to a mobile device for performing voice communication and data communication, the method comprising:
(a) the mobile device detecting a ringing signal or call signal of a call;
(b) the mobile device extracting a phone number from the detected ringing signal or call signal;
(c) the mobile device requesting the expression object server for a multimedia expression object corresponding to the extracted phone number;
(d) the expression object server searching a multimedia expression object corresponding to the extracted phone number and transmitting it to the mobile device; and
(e) the mobile device displaying the multimedia expression object at least one of the times for originating a call, receiving a call, in the middle of a call and at the end of a call.

2. The method of claim 1, further comprising
(f) a user information device manufacturing a multimedia expression object; and
(g) the user information device transmitting the manufactured multimedia expression object to the expression object server to store and register it.

3. The method of claim 1, wherein in the step of (d) the mobile device caches the multimedia expression object received from the expression object server in a storage device and re-uses the multimedia expression object.

4. The method of claim 1, wherein the multimedia expression object includes still images including a character string or a photograph, moving images, music and vibration data, and is output via a screen output device, a sound output device, or a vibration output device of the mobile device.

5. The method of claim 1, wherein the multimedia expression object includes an interaction object including buttons, icons, or menus, and the mobile device outputs various expression results by interacting with the user via the interaction object.

6. A system for providing a multimedia object, comprising:
a user mobile device for performing voice communication and data communication and requesting a communication party's terminal to transmit a first multimedia expression object or receiving and outputting a second multimedia expression object resulting from a request of the communication party's terminal; and
an expression object server connected to the user mobile device via a data communication network for storing an multimedia expression object corresponding to a phone number of the user mobile device or the communication party's terminal and transmitting the first multimedia expression object or the second multimedia expression object corresponding to a phone number requested by the user mobile device of the communication party's terminal to the communication party's terminal or the user mobile device.

7. The system of claim 6, wherein the multimedia expression object includes sense information including sight, hearing and touch which can be expressed by the user mobile device and one or more among user interface objects which can interact with a user to derive corresponding results.

8. The system of claim 6, wherein the user mobile device and the communication party's terminal perform a request including additional conditions including time and date at a time point of the request, and location of a requesting user besides the phone number when requesting the expression object server for the multimedia expression object.

9. The system of claim 6, wherein the expression object server stores a number of phone numbers to correspond to one multimedia expression object.

10. The system of claim 6, wherein the multimedia expression object includes indirect data referring to data of an external storage besides multimedia data, and the user mobile device or the communication party's terminal accesses to a server indicated by the referred data and downloads the indirect data when receiving the multimedia expression object.

11. The system of claim 6, wherein the multimedia expression object includes machine codes executable in the user mobile device or the communication party's terminal or script codes executable in an script engine of the user mobile device or the communication party's terminal.

12. The system of claim 6, further comprising a user information device for manufacturing the multimedia expression objects and uploading them to the expression object server.

13. The system of claim 6, wherein when the user mobile device or the communication party's terminal originates or receives a SMS message or a multimedia message, the expression object server transmits the multimedia expression object corresponding to a phone number of a party for receiving the corresponding message to the communication party's terminal or the user mobile device.

14. A system for providing a multimedia object comprising:
an output unit for detecting an originated or terminated call signal related to voice communication and communicating with an expression object server for providing a multimedia express object related to the voice communication;
an output unit for outputting the multimedia expression object;
an expression object processor for extracting a phone number from the originated or terminated call signal, caching the multimedia expression object received from the communication unit or outputting the multimedia expression object the output unit; and
a control unit for performing control so as to extract the phone number from the originated or terminated call signal and to request and receive the multimedia expression object corresponding to the extracted phone number from the expression object server when the originated or terminated call signal is detected.

15. The user mobile device of claim 14, further comprising an input unit for inputting a phone number related to the originated call and a command requesting voice communication.

16. The user mobile device of claim 14, wherein the expression object processor continues to output the multimedia expression object after the voice communication has been terminated and stops to output the multimedia expression object according to a separate event or a stop commend from a user.

17. The user mobile device of claim 14, wherein when an originated or terminated signal of a SMS message or a multimedia message is detected, the control unit requests the multimedia expression object corresponding to a phone number of a party related to the corresponding message from the expression object server.

18. The user mobile device of claim 14, wherein when the received multimedia expression object includes indirect data referring to data of an external storage, the control unit accesses to a server indicated by the referred data and downloads the indirect data.

19. An expression object server comprising:
a communication unit for receiving a message requesting a multimedia expression object corresponding to a phone number related to an originated or terminated call from a mobile device;
an expression object storage for storing a number of multimedia expression objects;
an expression object searcher for searching for the multimedia expression object corresponding to the phone number from the expression object storage; and
a control unit for searching for the multimedia expression object corresponding to the phone number when the message requesting the multimedia expression object and transmitting the multimedia expression object corresponding to the phone number to the mobile device via a data communication network.

20. The expression object server of claim 19, wherein the message requesting the multimedia expression object includes additional conditions including time and date at a time point of the request, and location of a requesting user.
